(19) United States
(12) Patent Application Publication
(10) Pub. No.: US 2025/0080622 A1
(43) Pub. Date: Mar. 6, 2025

(54) SERVICE PROXY DEVICE, SERVICE PROVIDING SYSTEM, AND SERVICE PROXY METHOD

(71) Applicant: Yazaki Corporation, Tokyo (JP)

(72) Inventor: Hiroyuki AISO, Shizuoka (JP)

(73) Assignee: Yazaki Corporation, Tokyo (JP)

(21) Appl. No.: 18/807,100

(22) Filed: Aug. 16, 2024

(30) Foreign Application Priority Data
Aug. 28, 2023 (JP) 2023-138077

(51) Int. Cl. H04L 67/561; H04L 67/5682

(52) U.S. Cl. CPC H04L 67/561; H04L 67/5682

(57) ABSTRACT

A service proxy device, a service providing system, and a service proxy method store a map table in a database, wherein the map table associates functions with services and identifies a server having the function and a client requesting the service, receive a service execution instruction requesting execution of the service from the client via a first communicator connected to the client via a first communication, receive an execution result of the function associated with the service from the server via a second communicator connected to the server via a second communication, and transmit the execution result of the function associated with the service to the client via the first communicator based on the service execution instruction and the map table.

### CROSS-REFERENCE TO RELATED APPLICATIONS

The present application is based on, and claims priority from Japanese Patent Application No. 2023-138077, filed on Aug. 28, 2023, the entire contents of which are incorporated herein by reference.

### TECHNICAL FIELD

The disclosure relates to a service proxy device, a service providing system, and a service proxy method.

### BACKGROUND

Japanese Patent Laid-Open Publication No. 2021-064827 discloses a conversion device that converts data of a signal communication ECU (Electronic Control Unit) into data of a service communication ECU based on a conversion map, and conversely converts data of the service communication ECU into data of the signal communication ECU. Here, when the conversion device detects that at least one of the signal communication ECU and the service communication ECU has been updated, the conversion device automatically updates the conversion map to change the manner of data conversion.

### SUMMARY OF THE INVENTION

According to the conversion device disclosed in Japanese Patent Laid-Open Publication No. 2021-064827, the conversion map is automatically updated based on the similarity of data. When a new service is to be supported, there is a possibility that the conversion map cannot be updated because there is no similar data. Furthermore, there is a problem that the conversion device cannot support a service that issues an operation instruction to the signal communication ECU.

The disclosure has been made in view of such problems of the conventional art. An object of the disclosure is to provide a service proxy device, a service providing system, and a service proxy method that can update a conversion map even when a new service is provided and can handle a service that issues an operation instruction to a signal communication ECU.

A service proxy device according to an aspect of the disclosure includes a first communicator connected to a client via a first communication, a second communicator connected to a server via a second communication, a database, and a controller. The database is configured to store a map table that associates functions with services and identifies a server having the function and a client requesting the service. The controller is configured to receive a service execution instruction from the client via the first communicator, which requests the execution of the service. The controller is configured to receive an execution result of the function associated with the service from the server via the second communicator. The controller is configured to transmit the execution result of the function associated with the service to the client via the first communicator based on the service execution instruction and the map table.

A service providing system according to an aspect of the disclosure includes the client, the server, and the above-mentioned service proxy device.

A service proxy method according to an aspect of the disclosure relates to a service proxy device including a first communicator connected to a client via a first communication, a second communicator connected to a server via a second communication, a database, and a controller. The database stores a map table that associates functions with services and identifies a server having the function and a client requesting the service. The controller receives a service execution instruction from the client via the first communicator, which requests the execution of the service. The controller receives an execution result of the function associated with the service from the server via the second communicator. The controller transmits the execution result of the function associated with the service to the client via the first communicator based on the service execution instruction and the map table.

According to the disclosure, it is possible to provide a service proxy device, a service providing system, and a service proxy method that can update a conversion map even when a new service is provided and can handle a service that issues an operation instruction to a signal communication ECU.

### BRIEF DESCRIPTION OF DRAWINGS

FIG. 1 is a block diagram showing a configuration of a service providing system according to an embodiment.

FIG. 2 is a block diagram showing a configuration of a service proxy device according to the embodiment.

FIG. 3 is a diagram showing an example of a map table.

FIG. 4 illustrates an example of a server management table.

FIG. 5 illustrates an example of a client management table.

FIG. 6A is a sequence chart illustrating a process at the time of startup.

FIG. 6B is a flowchart illustrating a process at the time of startup.

FIG. 7A is a sequence chart illustrating a process for responding to a service inquiry.

FIG. 7B is a flowchart illustrating a process for responding to a service inquiry.

FIG. 8A is a sequence chart illustrating a normal process.

FIG. 8B is a flowchart illustrating a normal process.

FIG. 9A is a sequence chart illustrating a process during service proxy.

FIG. 9B is a flowchart illustrating a process during service proxy.

FIG. 9C is a flowchart illustrating an acquisition process.

FIG. 9D is a flowchart illustrating an execution process.

### DETAILED DESCRIPTION OF THE INVENTION

Hereinafter, a service proxy device, a service providing system, and a service proxy method according to embodiments will be described in detail with reference to the drawings. Note that the dimensional ratio of the drawings is exaggerated for the sake of explanation and may differ from the actual ratio. Further, the same functions and elements are denoted by the same or similar reference numerals, and a description thereof will be omitted as appropriate.

### [Configuration Example of Service Providing System]

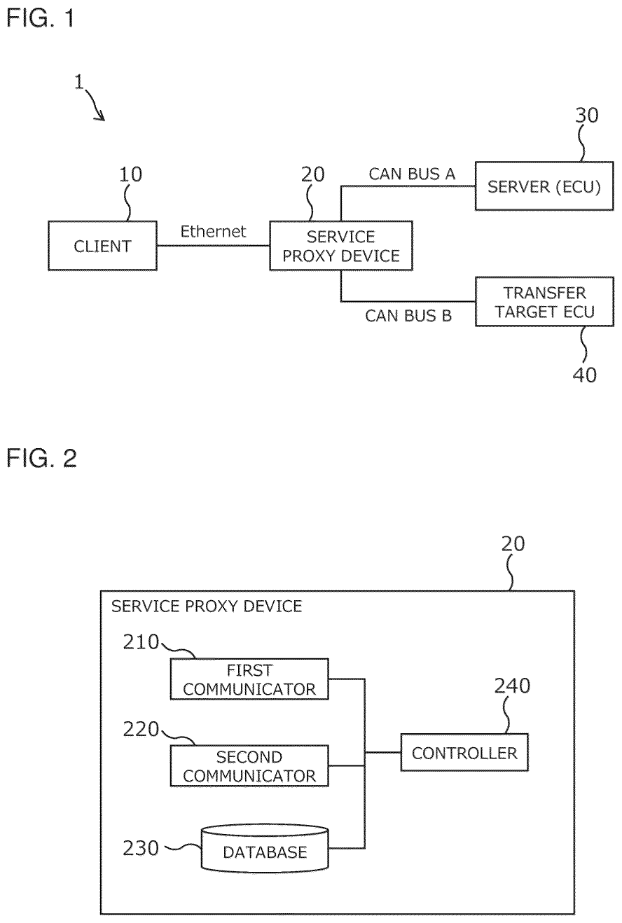

FIG. 1 is a block diagram showing a configuration of a service providing system according to an embodiment. The service providing system 1 includes a client 10, a server 30 (ECU: Electronic Control Unit), and a service proxy device 20, which will be described later. In addition, the service providing system 1 may include a transfer target ECU 40. For example, the service providing system 1 is mounted on a vehicle.

The client 10 and the service proxy device 20 are connected to each other so that data can be transmitted and received via a first communication. For example, the first communication is a service communication. The service communication is a communication method for transmitting and receiving data between a client and a server. An example of a network that realizes the service communication is the Ethernet.

The server 30 and the service proxy device 20 are connected to each other so that data can be transmitted and received by a second communication. The transfer target ECU 40 and the service proxy device 20 are connected to each other so that data can be transmitted and received by the second communication. For example, the second communication is a signal communication. The signal communication is a communication method for broadcasting data to ECUs (including the server 30 and the transfer target ECU 40) on a network. A CAN (Controller Area Network) bus is an example of a network that realizes the signal communication. FIG. 2 shows a state in which a CAN bus A is provided between the server 30 and the service proxy device 20, and a CAN bus B is provided between the transfer target ECU 40 and the service proxy device 20.

### [Configuration Example of Service Proxy Device]

FIG. 2 is a block diagram showing a configuration of a service proxy device according to the embodiment. The service proxy device 20 includes a first communicator 210, a second communicator 220, a database 230, and a controller 240. The first communicator 210 is connected to the client 10 via the first communication. The second communicator 220 is connected to the server 30 and the transfer target ECU 40 via the second communication.

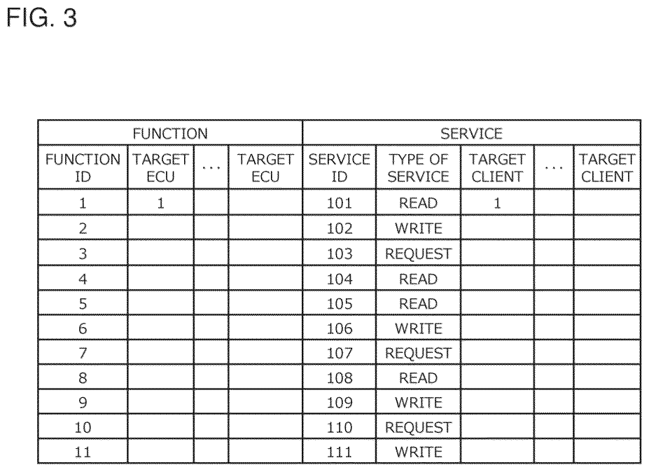

The database 230 stores a map table that associates functions with services and identifies the server 30 that has the functions and the client 10 that requests the service. FIG. 3 is a diagram showing an example of a map table. As shown in FIG. 3, the map table associates a function ID that identifies the function with a service ID that identifies the service. Furthermore, the map table may associate information that identifies the type of service with each service ID.

The map table may also associate, for each function ID, an ECU ID that identifies the server 30 having the function identified by the function ID. Furthermore, the map table may associate, for each service ID, a client ID that identifies the client 10 that requests the service ID.

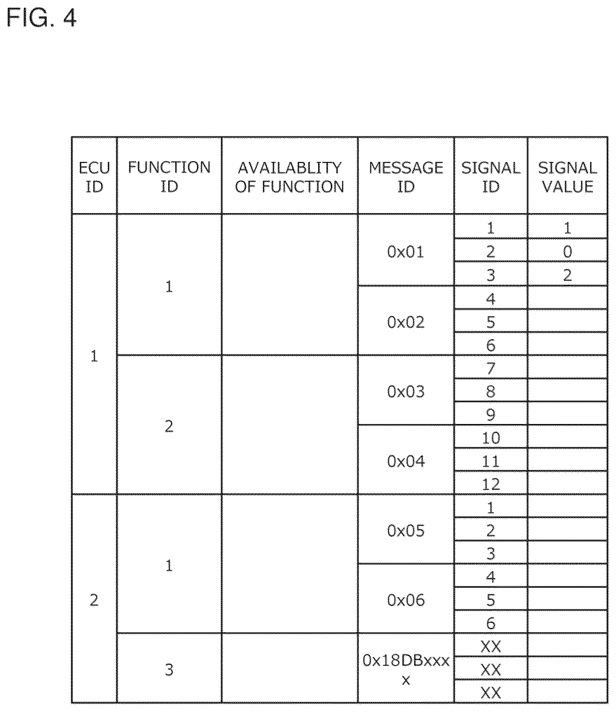

The database 230 may also store a server management table that associates the function with the server 30 and identifies whether the function in the server 30 is available. FIG. 4 illustrates an example of a server management table. The server management table associates information that identifies whether the function in the server 30 is available with an ECU ID that identifies the server 30. The server management table may also associate a message ID that identifies a message transmitted or received in the function with the function ID that identifies the function. The server management table may also associate, for each message ID, a signal ID that indicates a transfer destination of the message identified by the message ID, and a signal value. Here, the signal value corresponds to the execution result of the function in the server 30.

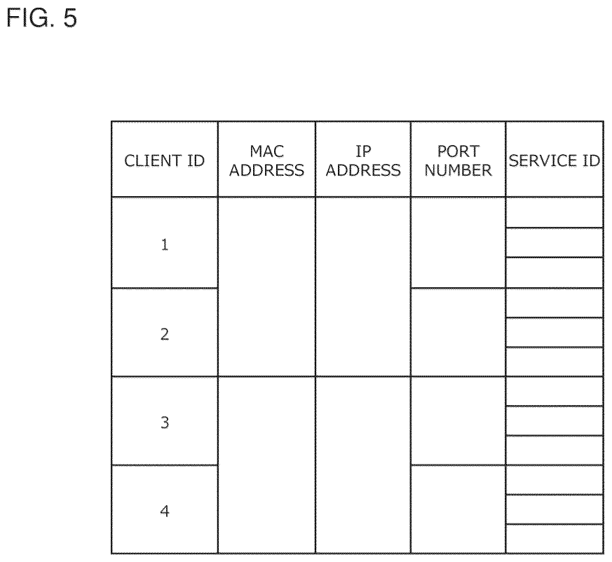

The database 230 may also store a client management table that identifies the service requested by the client 10 by associating the client 10 with the service. FIG. 5 illustrates an example of a client management table. The client management table associates the service ID that identifies the service requested by the client 10 with the client ID that identifies the client 10. Additionally, the client management table may associate connection destination information required for service communication with the client 10 with the client ID. For example, the client management table may associate a MAC address, an IP address, a port number, etc. as the connection destination information.

The controller 240 is a general-purpose computer equipped with a CPU (Central Processing Unit), a memory, a storage device, an input/output unit, etc. A computer program for functioning as a part of the service proxy device 20 is installed in the controller 240. The computer program may be stored in a recording medium that can be read and written by a computer. The computer program may be capable of being distributed through a network.

The controller 240 receives a service execution instruction requesting execution of the service from the client 10 via the first communicator 210. The controller 240 receives the execution result of the function associated with the service from the server 30 via the second communicator 220. Then, the controller 240 transmits the execution result of the function associated with the service to the client 10 via the first communicator 210 based on the service execution instruction and the map table.

Furthermore, the controller 240 may transmit a function check instruction for checking whether or not the function is available to the server 30 via the second communicator 220 and may receive answer data transmitted from the server 30 based on the function check instruction. The controller 240 may then update the server management table based on the received answer data. More specifically, the controller 240 updates information identifying whether or not a function is available to the server 30, which is stored in the server management table, based on the answer data.

The controller 240 may determine whether or not the function associated with the service related to the service execution instruction is available based on the server management table, and may transmit the execution result to the client 10 when it is determined that the function is available. The controller 240 may also receive the execution result from the server 30 via the first communicator 210 and may update the server management table by associating the function with the execution result.

The controller 240 may send a function execution instruction to the server 30 having the function, requesting the execution of the function associated with the service related to the service execution instruction, and may receive the execution result based on the function execution instruction from the server 30.

Furthermore, the controller 240 may receive a service check instruction for checking the presence or absence of the service from the client 10 via the first communicator 210. The controller 240 may then determine whether or not the function corresponding to the service exists based on the service check instruction and the map table. If the function corresponding to the service exists, the controller 240 may update the client management table and the map table based on the service check instruction.

In addition, the controller 240 may transfer a message received from the server 30 via the second communicator 220 to the transfer target ECU 40 identified by the signal ID indicating the transfer destination of the message. The controller 240 may update the server management table based on the message received from the server 30.

### [Procedure at Time of Startup]

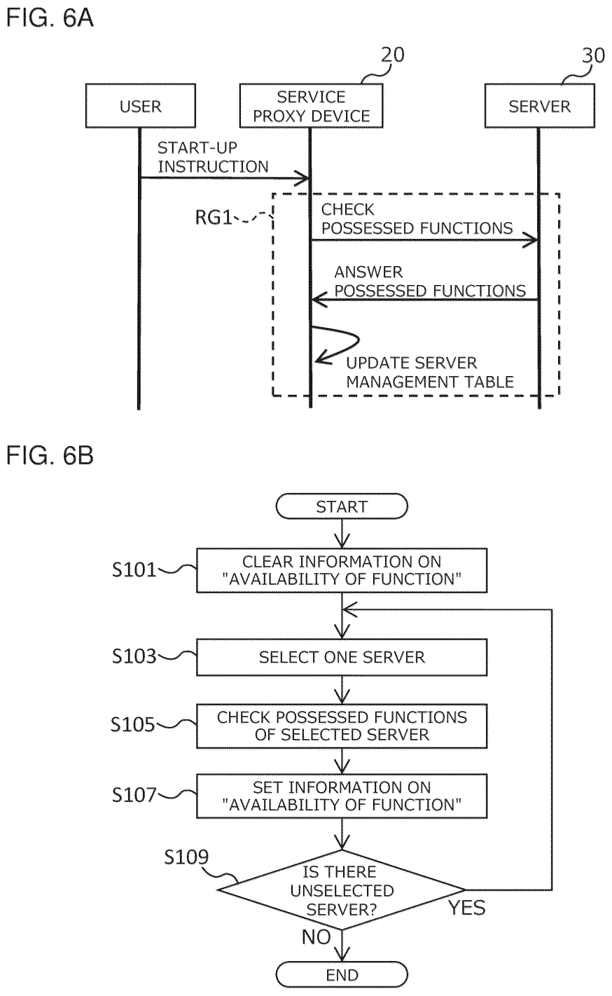

FIG. 6A is a sequence chart illustrating a process at the time of startup. As shown in FIG. 6A, the service proxy device 20 starts the process included in the range RG1 based on a start-up instruction from the user.

More specifically, the service proxy device 20 transmits the function check instruction to server 30 to check the functions possessed by the server 30 (“Check possessed functions”). When the server 30 receives the function check instruction, the server 30 transmits the answer data identifying the functions possessed by the server 30 itself to the service proxy device 20 (“Answer possessed functions”). The service proxy device 20 updates the server management table based on the answer data (“Update server management table”).

The processes included in the above-mentioned range RG1 are executed for each server 30 connected to the service proxy device 20.

FIG. 6B is a flowchart illustrating a process at the time of startup. In step S101, the controller 240 clears the information on “availability of function” contained in the server management table.

In step S103, the controller 240 selects one server 30 from among the unselected servers 30.

In step S105, the controller 240 checks the possessed functions of the selected server 30. Specifically, the controller 240 transmits the function check instruction to the selected server 30 via the second communicator 220. Thereafter, the controller 240 receives the answer data from the selected server 30.

In step S107, the controller 240 sets the information on “availability of function” that identifies whether or not the function held by the selected server 30 can be used, based on the answer data.

In step S109, the controller 240 determines whether or not there is an unselected server 30. If there is an unselected server 30 (YES in step S109), the process returns to step S103.

If there is no unselected server 30 (NO in step S109), service proxy device 20 ends the process at the time of startup.

### [Procedure for Responding to Service Inquiry]

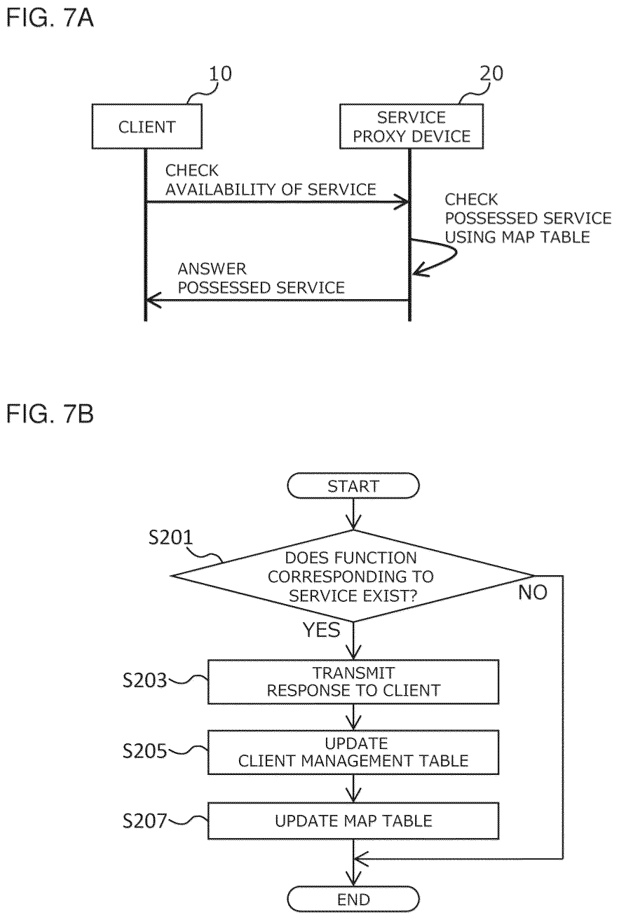

FIG. 7A is a sequence chart illustrating a process for responding to a service inquiry. As shown in FIG. 7A, the service proxy device 20 receives the service check instruction for checking the presence or absence of the service from the client (“Check availability of service”). The service proxy device 20 determines whether or not the function corresponding to the service exists based on the service check instruction and the map table (“Check possessed service using map table”). The service proxy device 20 then transmits the determination result of whether or not the function corresponding to the service exists to the client 10 (“Answer possessed service”).

FIG. 7B is a flowchart illustrating a process for responding to a service inquiry. In step S201, the controller 240 determines whether or not the function corresponding to the service exists based on the service check instruction and the map table.

If there is no function corresponding to the service (NO in step S201), the service proxy device 20 ends the process for responding to the service inquiry.

If the function corresponding to the service exists (YES in step S201), in step S203, the controller 240 transmits a response to the client 10 via the first communicator 210 indicating that the function corresponding to the service exists.

In step S205, the controller 240 updates the client management table based on the service check instruction. Specifically, the controller 240 associates the service ID that identifies the service requested by the client 10 with the client ID that identifies the client 10.

In step S207, the controller 240 updates the map table based on the service check instruction. Specifically, the controller 240 associates the client ID that identifies the client 10 that requests the service ID for each service ID. Thereafter, the service proxy device 20 ends the process for responding to the service inquiry.

The process for responding to the service inquiry shown in FIGS. 7A and 7B may be repeatedly executed after the process at the time of startup shown in FIGS. 6A and 6B.

### [Procedure at Normal]

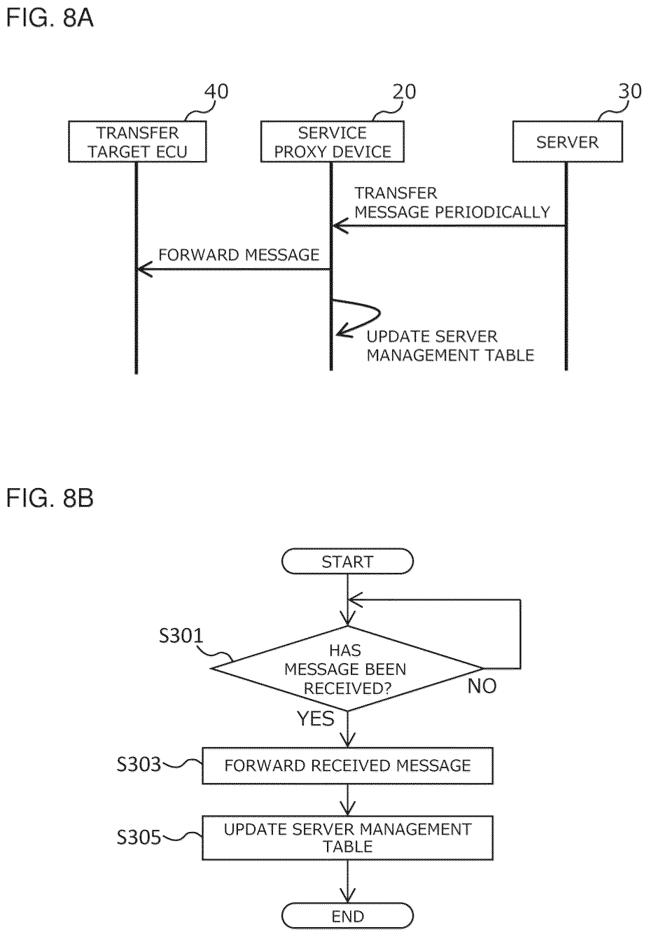

FIG. 8A is a sequence chart illustrating a normal process. As shown in FIG. 8A, the service proxy device 20 receives a message transmitted from the server 30 (“Transfer message periodically”), and then transfers the received message to the transfer target ECU 40 (“Forward message”). Then, the service proxy device 20 updates the server management table based on the received message (“Update server management table”).

FIG. 8B is a flowchart illustrating a normal process. In step S301, the controller 240 determines whether or not the message has been received from the server 30.

If no message has been received (NO in step S301), the process returns to step S301.

When a message has been received (YES in step S301), in step S303, the controller 240 forwards the received message to the transfer target ECU 40 via the second communicator 220.

In step S305, the controller 240 updates the server management table based on the received message. Specifically, the controller 240 associates the function ID that identifies the function with the message ID that identifies the message sent or received in the function. Additionally, the controller 240 may associate the signal ID and the signal value with each message ID, wherein the signal ID indicates the transfer destination of the message identified by the message ID. Thereafter, the service proxy device 20 ends the normal process.

The normal process shown in FIGS. 8A and 8B may be repeatedly executed after the process at the time of startup shown in FIGS. 6A and 6B.

### [Procedure During Service Proxy]

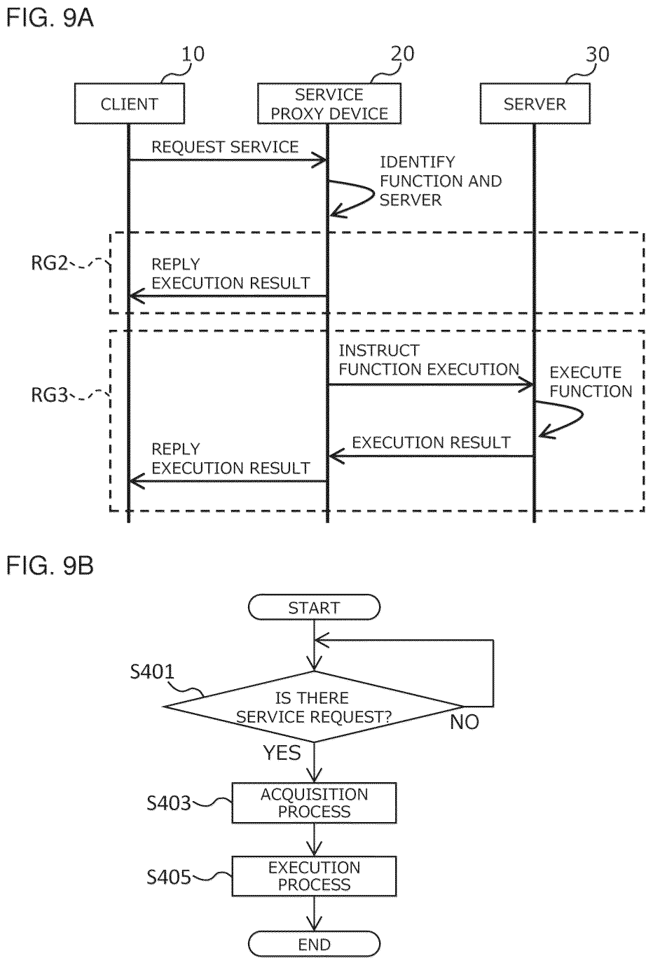

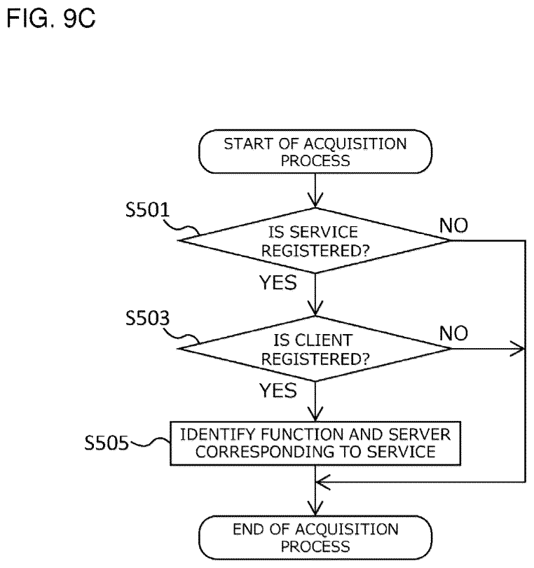

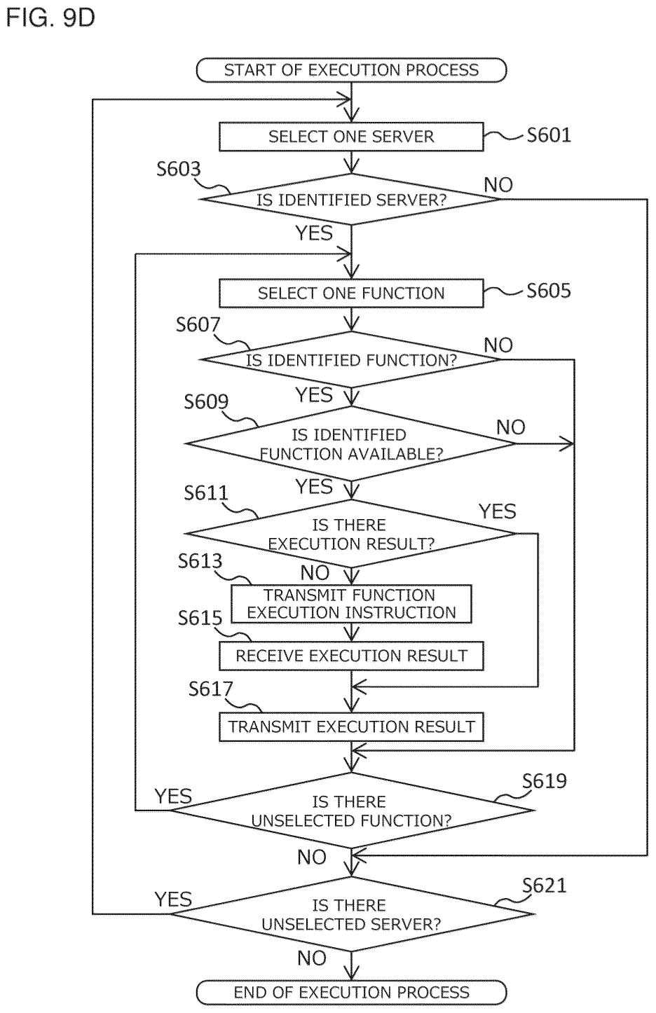

FIG. 9A is a sequence chart illustrating a process during service proxy. As shown in FIG. 9A, the service proxy device 20 receives the service execution instruction sent from the client 10 (“Request service”). Based on the service execution instruction, the service proxy device 20 identifies the function associated with the service identified by the service execution instruction and the server 30 having the function (“Identify function and server”).

If the execution result is registered in the map data, service proxy device 20 performs process in the range RG2. Specifically, the service proxy device 20 transmits the execution result to client 10 (“Reply execution result”).

If the execution result is not registered in the map data and it is necessary to obtain the execution result, the service proxy device 20 performs process in the range RG3.

Specifically, the service proxy device 20 transmits the function execution instruction to the server 30 (“Instruct function execution”). The server 30, which has received the function execution instruction, executes the function identified by the function execution instruction and transmits the execution result to the service proxy device 20 (“execution result”). Then, the service proxy device 20 transmits the execution result to the client 10 (“Reply execution result”).

FIG. 9B is a flowchart illustrating a process during service proxy. FIG. 9C is a flowchart illustrating an acquisition process. FIG. 9D is a flowchart illustrating an execution process.

In step S401, the controller 240 determines whether or not the service request has been made by the client 10. Specifically, the controller 240 determines whether or not the service execution instruction has been received from the client 10.

If there is no service request (NO in step S401), the process returns to step S401. If the service request has been received (YES in step S401), the controller 240 executes an acquisition process in step S403. The details of the acquisition process will be described with reference to FIG. 9C.

In step S405, the controller 240 executes an execution process. The details of the execution process will be described with reference to FIG. 9D.

Thereafter, the service proxy device 20 ends the process during service proxy.

FIG. 9C is a flowchart illustrating an acquisition process. In step S501, the controller 240 determines whether or not the service identified by the service execution instruction is registered. Specifically, the controller 240 determines whether or not the service is registered in the map table.

If the service is not registered (NO in step S501), the acquisition process is terminated. On the other hand, if the service is registered (YES in step S501), in step S503, the controller 240 determines whether or not the client is registered in association with the service. Specifically, the controller 240 refers to the map table and determines whether or not the client that transmitted the service execution instruction is associated with the service identified by the service execution instruction.

If the client is not registered (NO in step S503), the acquisition process ends. On the other hand, if the client is registered (YES in step S503), in step S505, the controller 240 refers to the map table to identify the function and server corresponding to the service. Then, the acquisition process ends.

FIG. 9D is a flowchart illustrating an execution process. In step S601, the controller 240 selects one server 30 from among the servers 30 that have not been selected.

In step S603, the controller 240 determines whether the selected server is the server 30 identified in the acquisition process.

If the selected server is not the identified server 30 (NO in step S603), the process proceeds to step S621.

On the other hand, if the selected server is the identified server 30 (YES in step S603), in step S605, the controller 240 selects one function from among the unselected functions.

In step S607, the controller 240 determines whether the selected function is the function identified in the acquisition process.

If the selected function is not the identified function (NO in step S607), the process proceeds to step S619.

On the other hand, if the selected function is the identified function (YES in step S607), in step S609, the controller 240 determines whether or not the identified function is available in the identified server 30. Specifically, the controller 240 refers to the server management table to determine whether or not the function is available.

If the function is not available (NO in step S609), the process proceeds to step S619.

On the other hand, if the function is available (YES in step S609), in step S611, the controller 240 determines whether or not there is the execution result that takes into consideration the identified function in the identified server 30. Specifically, the controller 240 refers to the server management table and determines whether or not the execution result is registered.

If there is the execution result (YES in step S611), the process proceeds to step S617. On the other hand, if there is no execution result (NO in step S611), the controller 240 transmits the function execution instruction to the identified server 30 in step S613.

Thereafter, in step S615, the controller 240 receives the execution result from the server 30.

In step S617, the controller 240 transmits the execution result to the client 10. In step S619, the controller 240 determines whether or not there is the unselected function. If there is the unselected function (YES in step S619), the process returns to step S605.

If there is no unselected function (NO in step S619), in step S621, the controller 240 determines whether or not there is the unselected server 30. If there is the unselected server 30 (YES in step S621), the process returns to step S601.

If there is no unselected server 30 (NO in step S621), the service proxy device 20 ends the execution process.

The process during service proxy shown in FIGS. 9A to 9D may be repeatedly executed after the process at the time of startup shown in FIGS. 6A and 6B.

### Effects of the Embodiments

As explained in detail above, a service proxy device according to the present embodiment includes a first communicator connected to a client via a first communication, a second communicator connected to a server via a second communication, a database, and a controller. The database is configured to store a map table that associates functions with services and identifies a server having the function and a client requesting the service. The controller is configured to receive a service execution instruction from the client via the first communicator, which requests the execution of the service. The controller is configured to receive an execution result of the function associated with the service from the server via the second communicator. The controller is configured to transmit the execution result of the function associated with the service to the client via the first communicator based on the service execution instruction and the map table.

This allows a conversion map to be updated when supporting new services, and it possible to support services that provide operational instructions in signal communication. Also, communication is possible across different communication methods between clients and servers, making it possible to provide a variety of services without changing the communication method of existing servers. As a result, it is possible to reduce the cost and workload during design and manufacturing of a system in which communication occurs between clients and servers. Furthermore, user convenience is improved.

Further, in the service proxy device according to the present embodiment, the database may store a server management table that identifies whether the function is available or not in association with the server. Via the second communicator, the controller may transmit a function check instruction to the server to check whether the function is available, and may receive an answer data transmitted from the server based on the function check instruction. The controller may update the server management table based on the answer data. This allows the service proxy device to centrally manage functions available on the server, and makes it easy to determine whether the service can be provided.

Furthermore, in the service proxy device according to the present embodiment, the controller may determine whether the function associated with the service related to the service execution instruction is available based on the server management table. The controller may transmit the execution result to the client in a case of determining that the function is available. This allows the client to be notified of whether or not the requested service can be provided using the server connected to the service proxy device. As a result, user convenience is improved.

Further, in the service proxy device according to the present embodiment, the controller may receive the execution result from the server via the first communicator, and may update the server management table by associating the function with the execution result. This allows the service proxy device to centrally manage the execution results of the function on the server. For example, for a function that is periodically executed on the server, the execution results periodically transmitted can be centrally managed by the service proxy device.

Furthermore, in the service proxy device according to the present embodiment, the controller may transmit a function execution instruction to the server that has the function, the function execution instruction requesting execution of the function associated with the service related to the service execution instruction. The controller may receive, from the server, the execution result based on the function execution instruction. This allows the function related to the requested service to be executed in the server, and the requested service to be provided. As a result, user convenience is improved.

Further, in the service proxy device according to the present embodiment, the database may store a client management table that identifies the service requested by the client in association with the client. The controller may receive a service check instruction for checking presence or absence of the service from the client via the first communicator. The controller may determine whether the function corresponding to the service exists based on the service check instruction and the map table. The controller may update the client management table and the map table based on the service check instruction if the function corresponding to the service exists. This allows the service requested by the client to be linked with the function provided by the server and managed in a centralized manner. As a result, it becomes possible to easily determine whether or not a service can be provided.

A service providing system according to the present embodiment includes the client, the server, and the above-mentioned service proxy device. This allows a conversion map to be updated when supporting new services, and it possible to support services that provide operational instructions in signal communication.

A service proxy method according to the present embodiment, relates to a service proxy device including a first communicator connected to a client via a first communication, a second communicator connected to a server via a second communication, a database, and a controller. The database is configured to store a map table that associates functions with services and identifies a server having the function and a client requesting the service. The controller is configured to receive a service execution instruction from the client via the first communicator, which requests the execution of the service. The controller is configured to receive an execution result of the function associated with the service from the server via the second communicator. The controller is configured to transmit the execution result of the function associated with the service to the client via the first communicator based on the service execution instruction and the map table.

This allows a conversion map to be updated when supporting new services, and it possible to support services that provide operational instructions in signal communication.

Respective functions described in the above embodiment may be implemented by one or plural processing circuits. The processing circuits include programmed processors, electrical circuits, etc., as well as devices such as application specific integrated circuits (ASIC) and circuit components arranged to perform the described functions, etc.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A service proxy device comprising
a first communicator connected to a client via a first communication,
a second communicator connected to a server via a second communication,
a database, and
a controller, wherein
the database is configured to
store a map table that associates functions with services and identifies the server having the function and the client requesting the service,
the controller is configured to
receive, via the first communicator, a service execution instruction requesting execution of the service from the client,
receive, via the second communicator, an execution result of the function associated with the service from the server, and
transmit, via the first communicator, the execution result of the function associated with the service based on the service execution instruction and the map table, to the client.

2. The service proxy device according to claim 1, wherein
the database is configured to
store a server management table that identifies whether the function is available or not in association with the server,
the controller is configured to, via the second communicator,
transmit a function check instruction to the server to check whether the function is available,
receive an answer data transmitted from the server based on the function check instruction, and
update the server management table based on the answer data.

3. The service proxy device according to claim 2, wherein
the controller is configured to
determine whether the function associated with the service related to the service execution instruction is available based on the server management table, and
transmit the execution result to the client in a case of determining that the function is available.

4. The service proxy device according to claim 2, wherein
the controller is configured to
receive the execution result from the server via the first communicator, and
update the server management table by associating the function with the execution result.

5. The service proxy device according to claim 1, wherein
the controller is configured to
transmit a function execution instruction to the server that has the function, the function execution instruction requesting execution of the function associated with the service related to the service execution instruction, and
receive, from the server, the execution result based on the function execution instruction.

6. The service proxy device according to claim 1, wherein
the database is configured to
store a client management table that identifies the service requested by the client in association with the client,
the controller is configured to
receive a service check instruction for checking presence or absence of the service from the client via the first communicator,
determine whether the function corresponding to the service exists based on the service check instruction and the map table, and
update the client management table and the map table based on the service check instruction if the function corresponding to the service exists.

7. A service providing system comprising
a client,
a server, and
a service proxy device, wherein
the service proxy device includes
a first communicator connected to the client via a first communication,
a second communicator connected to the server via a second communication,
a database, and
a controller, wherein
the database is configured to
store a map table that associates functions with services and identifies the server having the function and the client requesting the service,
the controller is configured to
receive, via the first communicator, a service execution instruction requesting execution of the service from the client,
receive, via the second communicator, an execution result of the function associated with the service from the server, and
transmit, via the first communicator, the execution result of the function associated with the service based on the service execution instruction and the map table, to the client.

8. A service proxy method for a service proxy device including a first communicator connected to a client via a first communication, a second communicator connected to a server via a second communication, a database, and a controller,
the service proxy method comprising,
by using the database,
storing a map table that associates functions with services and identifies the server having the function and the client requesting the service,
by using the controller,
receiving, via the first communicator, a service execution instruction requesting execution of the service from the client,
receiving, via the second communicator, an execution result of the function associated with the service from the server, and
transmitting, via the first communicator, the execution result of the function associated with the service based on the service execution instruction and the map table, to the client.
